(19) United States
(12) Patent Application Publication
(10) Pub. No.: US 2017/0290723 A1
(43) Pub. Date: Oct. 12, 2017

(54) SEATING SYSTEM HAVING PRESSURE COMPENSATING FLUID WITH THERMAL CONDUCTION PROPERTIES

(71) Applicant: Sunrise Medical (US) LLC, Fresno, CA (US)

(72) Inventors: James Christofferson, Longmont, CO (US); Gary Hite, Longmont, CO (US)

(73) Assignee: Sunrise Medical (US) LLC, Fresno, CA (US)

(21) Appl. No.: 15/256,181

(22) Filed: Sep. 2, 2016

Related U.S. Application Data
(60) Provisional application No. 62/319,098, filed on Apr. 6, 2016.

(51) Int. Cl. A61G 5/10; A47C 7/74; C08K 3/04; A47C 27/08; C08K 5/09; C08K 7/16

(52) U.S. Cl. CPC A61G 5/1091; C08K 5/09; C08K 7/16; C08K 3/042; A47C 27/085; A47C 7/746; A47C 7/748; C08K 2201/011; C08K 2201/005

(57) ABSTRACT

A seating system, particularly suited for personal mobility vehicles, such as wheelchairs, includes a seat cushion having pressure relieving properties and enhanced thermal conduction properties. The seat cushion includes a thixotropic fluid contained within a flexible envelope. The thixotropic fluid includes nanoparticles that enhance the thermal conduction properties of the seat cushion to increase heat transfer from a seated user to provide a reduced temperature sensory effect.

### CROSS-REFERENCE TO RELATED APPLICATIONS

This application claims the benefit of U.S. Provisional Application No. 62/319,098, filed Apr. 6, 2016, the disclosure of which is incorporated herein by reference.

### BACKGROUND OF THE INVENTION

This invention relates in general to seating systems. In particular, certain embodiments relate to pressure relieving seats having enhanced thermal conduction properties. In at least one embodiment, the invention provides a fluid-filled, pressure compensating seat cushion, particularly suited for personal mobility vehicles, having an adjustable thermal conduction characteristic.

Seating systems, particularly for personal mobility vehicles, such as wheelchairs, having fluid-filled cushions are known in the art. Once such type of cushion and fluid system is disclosed in U.S. Pat. No. 5,869,164 to Nickerson, et al., the disclosure of which is incorporated by reference in its entirety. This type of fluid-filled cushion utilizes a thixotropic fluid formed from an oil and a block polymer. The block polymer includes both oil-compatible and oil-incompatible portions of the polymeric chain. Microspheres are added to decrease the fluid density and the overall weight of the cushion and to provide an adjustment to fluid viscosity. The resulting thixotropic fluid provides support by conforming to the contours of contacted body parts, deforms in response to a continuously applied pressure, and maintains the deformed shape and position in the absence of the continuously applied pressure.

The fluid, particularly when positioned in a stabilized temperature environment, does not promote a desired level of heat movement from the seated user (heat source) into the fluid and on to the surrounding thermal environment. Such heat movement away from a user has a comforting feel, much like the familiar feel of a cool pillow. The movement of heat away from the area of user contact influences both the temperature and humidity levels of the microclimate of the cushion-body interface, which impacts metabolic and physical conditions of the user's skin. Since comfort levels are influenced by heat and moisture characteristics, reducing heat and moisture levels provides an increase in comfort level. Thus, it would be desirable to improve the thermal conductivity of a pressure compensating, fluid-filled seat cushion.

### SUMMARY OF THE INVENTION

This invention relates to personal mobility seating systems. In particular, the invention relates to pressure relieving seat cushions having enhanced thermal conduction properties. In at least one embodiment, the invention provides a fluid- filled, pressure compensating seat cushion, particularly suited for personal mobility vehicles, having an adjustable thermal conduction characteristic. The seat cushion includes a flexible polymer envelope and a thixotropic fluid contained within the flexible polymer envelope. The thixotropic fluid includes a base fluid having an oil and a block polymer. The block polymer has a first portion that has an affinity to the oil and a second portion. The first and second portions interact to provide a fluid viscosity that deforms under a generally constantly applied pressure and retains the deformed shape when the pressure is removed. The thixotropic fluid further has a concentration of nanoparticles that increase heat transfer from a seated user to provide a reduced temperature sensory effect.

The invention further relates to a seat cushion having a flexible polyurethane envelope and a thixotropic fluid contained within the envelope where the thixotropic fluid includes a base fluid having an oil and one of a di-block and a tri-block polymer. The polymer, either formed as the di-block or the tri-block polymer has a first portion that has an affinity to the oil and a second portion. The first and second portions interacting to provide a fluid viscosity that deforms under a generally constantly applied pressure and retains the deformed shape when the pressure is removed. The thixotropic fluid has concentration of nanoparticles configured to increase heat transfer from a seated user to provide a reduced temperature sensory effect. In one embodiment, the base fluid is formulated with the tri-block polymer that includes a third portion having the same oil affinity as the first portion.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is an exploded, perspective view of an embodiment of a seat cushion assembly including a thermally conductive, pressure compensating fluid.

FIG. 2 is a photomicrograph of an embodiment of a nanoparticle constituent of the thermally conductive, pressure compensating fluid of FIG. 1.

### DETAILED DESCRIPTION OF THE PREFERRED EMBODIMENTS

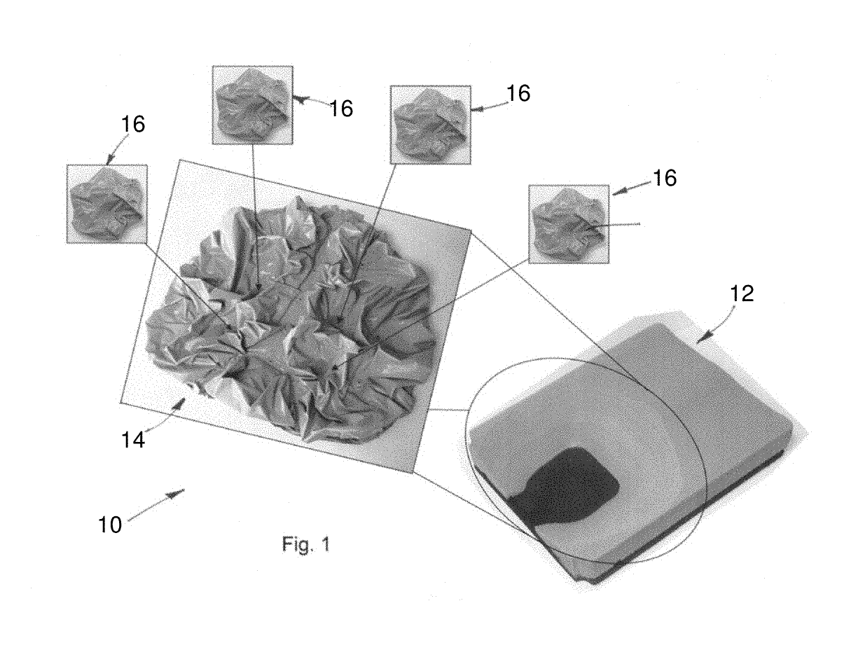

Referring now to the drawings, there is illustrated in FIG. 1 a pressure compensating, fluid-filled seating structure, shown generally at 10, that is configured for use in a personal mobility vehicle, such as a wheelchair or scooter. The seating structure 10 includes a foundation cushion 12, a central fluid pad 14, and a plurality of secondary fluid pads 16. The fluid pads 14 and 16 include a pressure-compensating fluid composition. The pads 14 and 16 may have the same or different fluid formulations, that provide both support and temperature control of a seated user. In one embodiment, the fluid is formulated from a block polymer, an oil, and a proportioned quantity of microspheres and nanoparticles. The fluid pads 14 and 16 have an outer containment structure configured as a polymer bag or envelope that is flexible in response to an applied pressure. In one embodiment, the polymer bag is a polyurethane envelope. In other embodiments, the flexible polymer envelope may be formed from any suitable flexible material that is chemically compatible with the thixotropic, pressure relieving and thermally conductive fluid. The nanoparticles are formulated and constructed to increase the thermal energy transfer from a heat source, such as the seated user in contact with the fluid pads 14 and 16, to the fluid composition, and subsequently to the atmosphere. While the seating structure 10 is shown having a plurality of cushion elements, such is not required. The seating structure may alternatively comprise a single fluid-filled envelope of any size, shape, and thickness.

In another embodiment, thermal energy transfer, in the form of heat, may also be increased and directed back to the user. Active cooling and heating may utilize a thermoelectric generator that is configured to drive a temperature gradient across the fluid (thermoelectric on one side of the fluid bladder and the user on the other). In one embodiment, the heat transfer may act in a manner similar to a heating pad. In another embodiment, the thermal pumping mechanism, such as the thermoelectric generator, of the nano-particle fluid may be switch from directing heat to the user to directing heat away from the user, or visa versa.

The fluid composition is a viscous fluid having a base of an oil and a block polymer. The block polymer may be configured as a di-block polymer or a tri-block polymer. The di-block polymer includes two sections having different affinity characteristics with respect to the oil. One of the block sections, such as an elastomer block, has a strong affinity to the oil and the other while the other block section, such as a rigid polystyrene block, has a poor affinity to the oil. In one embodiment, the rigid polystyrene blocks have a strong affinity to each other causing these blocks to cluster together. Consequently, the elastomer based blocks will radiate outwardly. As the concentration of di-block clusters becomes sufficient, the elastomer block section tend to entangle, causing the fluid to take on a thixotropic flow characteristic. This thixotropic characteristic tends to cause the fluid to deform in response to a constantly applied pressure and to maintain the deformed shape when the pressure is removed. The tri-block polymer includes three sections where the end sections have a different oil affinity than the center polymer block section. In one embodiment, the di-block polymer may be a polystyrene/polybutadiene or polystyrene/polyisoprene block. The polystyrene portion exhibits a weak or poor affinity to the oil and the polybutadiene or polyisoprene block exhibits a strong affinity for the oil. The oil may be a polyalphaolefin oil or vegetable oil, such as canola oil. Alternatively, the fluid base composition may be an emulsified, thixotropic paste formulated similar to grease.

The base blend of oil and block polymer may form micelles based on the polarizing effect of the di-block constituents combining with the selected oil. The base blend fluid may include hollow or low density, solid microspheres in order to decrease the density of the formulation and adjust the blend to a desired viscosity. The microspheres may be plastic in composition and may include a gas to fill the hollow center. In one embodiment, the microspheres may be a polyacrilonitrile and polymethylmethacrylate (PAN/PMMA) material filled with isobutane gas. In one embodiment, the fluid blend of oil, block polymer and microspheres may exhibit a viscosity in a range of about 100,000-300,000 centipoise. In another embodiment, the viscosity range may be in a range of about 180,000 to 200,000 centipoise. In addition, supplemental thickeners may also be added to adjust the final viscosity level.

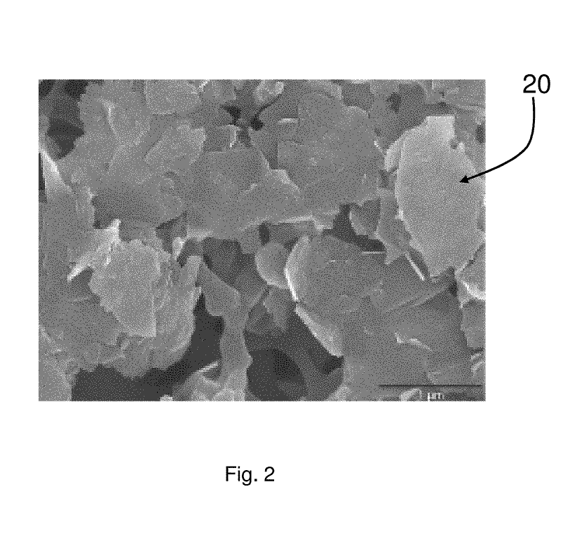

In order to improve the thermal conductivity of the fluid, nanoparticles may be added to increase heat transfer from the user to the fluid. Nanoparticles made from materials having higher values of thermal conductivity (expressed in W/(m-K)), such as metals or graphine, provide an improved heat transfer capability of the supporting fluid. The nanoparticles made be formed in any suitable shape, such as tubular, round, spherical, disk, platelet, amorphous particulate, or combination thereof and any arrangement such as long or short, tangled, striated, or parallel. In one embodiment, the nanoparticles may be of a generally round shape forming nanospheres. In another embodiment, shown in FIG. 2, the nanoparticles are graphine nanoplatelets 20. In one embodiment, the nanoparticles have a size range from about 1 to 20 nanometers thick and about 1 to 50 microns wide. The nanoparticles, and in one particular embodiment of nanoplatelets, may be provided in a weight fraction range of up to 20%. In another embodiment, the nanoplatelets may be in a weight fraction range from about 1-10%. In yet another embodiment, the weight fraction range may be about 4-6%.

The nanoparticles may be mixed into the base fluid by stirring or shaking in order to provide a generally homogenous and even dispersion. The even dispersion of nanoparticles in the base fluid facilitates a more even heat transfer over the surface area of the seat pads 14 and 16. The more even heat transfer provides an improved perception of comfort and cooling to the seated user.

Experimental data has verified the effect of improved thermal conductivity with the addition of graphine nanoparticles. Three samples each of the base fluid and the nanoparticle enhanced fluid were subjected to testing and measurement of thermal properties. The base fluid and the nanoparticle enhanced base fluid both contained microspheres or micro-balloons which are added to reduce the fluid density and increase the fluid viscosity. Thermal conductivity of the samples were measured using a modified transient plane source sensor, placed in contact with each of the specimens. The thermal conductivity was measured at a test temperature of approximately 23 degrees C. Test samples for the base fluid (without nanoplatelets) yielded thermal conductivity measurements of 0.087 W/m-K, 0.086 W/m-K and 0.085 W/m-K. Test samples having a weight fraction of about 4% graphine nanoparticles added to the base fluid yielded results of 0.118 W/m-K, 0.111 W/m-K, and 0.119 W/m-K. Thus, the effectiveness of nanoparticles in increasing thermal conductivity of the thixotropic pressure-compensating support fluid has been demonstrated and verified.

Additional testing on samples of base fluid material without the addition of microspheres (referred to as “grease”) and with varying amounts of graphine also confirm improved thermal conductivity. In addition, the graphine material provides the ability to increase fluid density, albeit at a higher fluid density as compared to fluids using microspheres. Under similar test conditions to those above, three specimens were each sampled three times and the results listed in the table below.

| | | | Apparent | | | |
|---|---|---|---|---|---|---|
| | Nominal | Sensor | Thermal | | Derived | |
| Speci- | Temper- | Temper- | Conduc- | Standard | Specific | Test |
| men | ature | ature | tivity | Deviation | Heat | Num- |
| ID | (° C.) | (° C.) | (W/m · K) | (W/m · K) | (J/kg-K) | ber |
| #1 | 23 | 24.7 | 0.419 | 0.001 | 3005 | 566 |
| 50-50 | | 24.5 | 0.414 | 0.001 | 2972 | 567 |
| | | 23.1 | 0.433 | 0.001 | 3087 | 572 |
| Averages | | | 0.422 | — | 3021 | — |
| #2 | 23 | 24.4 | 0.430 | 0.001 | 3388 | 588 |
| 50-25 | | 24.2 | 0.527 | 0.002 | 3627 | 589 |
| | | 23.2 | 0.496 | 0.002 | 3456 | 573 |
| Averages | | | 0.501 | — | 3483 | — |
| #3 | 23 | 24.1 | 0.557 | 0.002 | 3776 | 570 |
| 50-15 | | 23.9 | 0.552 | 0.001 | 3747 | 571 |
| | | 23.3 | 0.526 | 0.002 | 3612 | 574 |

| | | | | |
|---|---|---|---|---|
| Averages | 0.545 | — | 3712 | — |

The samples listed under “Specimen ID include different amounts of graphine, by weight, added to the base fluid grease. Specimen #1 50-50 included graphine in a range of about 10% to about 10.5% by weight. Specimen #2 50-25 included graphine in a range of 13% to 13.5% by weight. Specimen #3 50-15 included graphine in a range of about 15% to about 15.5% by weight. The test results show improved thermal conductivity as the graphine content increases.

Within and above the ranges and amounts of nanoparticles described above, the addition of nanoparticles to the base fluid influences the overall viscosity of the fluid. Increases in fluid viscosity influences the support characteristics of the seat cushions, particularly where boney protuberances, such as the ischial tuberosities, are involved in supporting the seated weight of a user. Thus, there is a desired range of viscosity to support a user's weight and provide isolation of these pressure points. A target viscosity of about 100,000 to 300,000 Cp provides a desired seating feel to a user and tends to support areas around the boney protuberances, such as the ischial tuberosities which minimize focused pressure on the skin against these protuberances. The increases in viscosity with the addition of nanoparticles may be compensated for by reducing the volume of microspheres. The tradeoff is an increased material density and higher cushion weight. In one embodiment, the weight fraction of graphine added to the base fluid without microspheres is in a range of 10-15% and produces a viscosity similar to the base fluid with microspheres in the range of about 100,000 to 300,000 Cp.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A seat cushion comprising:
a flexible polymer envelope; and
a thixotropic fluid contained within the flexible polymer envelope, the thixotropic fluid including a base fluid comprising an oil and a block polymer, the block polymer having a first portion that has an affinity to the oil and a second portion, the first and second portions interacting to provide a fluid viscosity that deforms under a generally constantly applied pressure and retains the deformed shape when the pressure is removed, the thixotropic fluid having concentration of nanoparticles configured to increase heat transfer from a seated user to provide a reduced temperature sensory effect.

2. The seat cushion of claim 1 wherein the nanoparticles have a geometric shape of at least one of a tubular, round, spherical, disk, platelet, and amorphous particulate.

3. The seat cushion of claim 2 wherein the nanoparticles are nanoplatelets having a size range of about 1 to 20 nanometers thick and about 1 to 50 microns wide.

4. The seat cushion of claim 3 wherein the nanoplatelets are provided in a weight fraction range of up to 20% of the base fluid.

5. The seat cushion of claim 4 wherein the weight fraction range is about 10-15%.

6. The seat cushion of claim 4 wherein the weight fraction range is about 4-6% and the base fluid includes microspheres, the base fluid having a viscosity in the range of about 100,000 to 300,000 Cp.

7. The seat cushion of claim 2 wherein the base fluid block polymer is a di-block polymer formed from one of polystyrene/polybutadiene and polystyrene/polyisoprene, the polystyrene block forming the second portion providing a weak affinity to the oil and the one of polybutadiene or polyisoprene block exhibits a strong affinity for the oil.

8. The seat cushion of claim 7 wherein the oil is one of a polyalphaolefin oil, a vegetable oil, and a synthetic oil.

9. The seat cushion of claim 8 wherein the oil is a canola oil.

10. The seat cushion of claim 7 wherein the base fluid includes microspheres.

11. A seat cushion comprising:
a flexible polyurethane envelope; and
a thixotropic fluid contained within the envelope, the thixotropic fluid including a base fluid comprising an oil and one of a di-block and a tri-block polymer, the polymer having a first portion that has an affinity to the oil and a second portion, the first and second portions interacting to provide a fluid viscosity that deforms under a generally constantly applied pressure and retains the deformed shape when the pressure is removed, the thixotropic fluid having concentration of nanoparticles configured to increase heat transfer from a seated user to provide a reduced temperature sensory effect.

12. The seat cushion of claim 11 wherein the base fluid comprises the oil and the tri-block polymer, the tri-block polymer includes a third portion that has the same oil affinity as the first portion.

13. The seat cushion of claim 11 wherein the heat transfer increase is proportional to the percent weight fraction of nanoparticles.

14. The seat cushion of claim 13 wherein the nanoparticles are provided in a weight fraction range of up to 20% of the base fluid.

15. The seat cushion of claim 14 wherein the weight fraction range is about 10-15%.

16. The seat cushion of claim 15 wherein the weight fraction range is about 4-6% and the base fluid includes microspheres, the base fluid having a viscosity in the range of about 100,000 to 300,000 Cp.

17. The seat cushion of claim 16 wherein the nanoparticles are nanoplatelets.

18. The seat cushion of claim 17 wherein the nanoplatelets are graphene nanoplatelets.

19. The seat cushion of claim 1 wherein a thermoelectric is provided to drive a temperature gradient across the fluid bladder to either heat or cool the user.
